(19) United States
(12) Patent Application Publication
(10) Pub. No.: US 2012/0011490 A1
(43) Pub. Date: Jan. 12, 2012

(54) DEVELOPMENT SYSTEM

(75) Inventors: Atsushi Mizuno, Kanagawa (JP); Shigeaki Takaki, Kanagawa (JP)

(73) Assignee: Kabushiki Kaisha Toshiba, Tokyo (JP)

(21) Appl. No.: 13/070,354

(22) Filed: Mar. 23, 2011

(30) Foreign Application Priority Data
Jul. 9, 2010 (JP) 2010-157211
Jul. 16, 2010 (JP) 2010-162172

(51) Int. Cl. G06F 9/44

(52) U.S. Cl. 717/127

(57) ABSTRACT

According to one embodiment, a development system includes an instruction set simulator (ISS) and a checker. The ISS includes a central processing unit (CPU) model that simulates an execution program and a memory model as a work area of the processor model. The checker monitors execution of an access instruction, included in the execution program, on the memory model and, when a difference between a data length at the time of writing and a data length at the time of reading on the same spot is detected, notifies an execution spot at the time of detection as an endian dependent spot.

### CROSS-REFERENCE TO RELATED APPLICATIONS

This application is based upon and claims the benefit of priority from the prior Japanese Patent Application No. 2010-157211, filed on Jul. 9, 2010, and the prior Japanese Patent Application No. 2010-162172, filed on Jul. 16, 2010; the entire contents of all of which are incorporated herein by reference.

### FIELD

Embodiments described herein relate generally to a development system.

### BACKGROUND

Conventionally, when software developed for a certain processor is ported to another processor that is different in endian type from the original processor, if an endian dependent code is included in the software, it is necessary to revise the endian dependent code.

Further, there is a computer system that includes a plurality of processor cores and performs data communication (data transmission) between processor cores through shared memory. In this system, if the processor cores are different in endian type from each other, a program is required not to cause a mismatch between data before and after transmission, which results from the difference in endian type when communication data (transmission data) is transferred between the processor cores.

### BRIEF DESCRIPTION OF THE DRAWINGS

FIG. 1 is a block diagram illustrating a hardware configuration example of a development system according to a first embodiment.

FIG. 2 is a diagram for explaining an example of a target program.

FIG. 3 is a block diagram for explaining a functional configuration of the development system according to the first embodiment.

FIG. 4 is a diagram for explaining a data structure example of an access history table.

FIG. 5 is a flowchart for explaining an operation of the development system according to the first embodiment.

FIG. 6 is a diagram illustrating a functional configuration of a development system according to a second embodiment.

FIG. 7 is a flowchart for explaining an operation of a development system according to the second embodiment.

FIG. 8 is a diagram for explaining a functional configuration of a development system with a model for simulating behavior of a hardware resource.

FIG. 9 is a diagram for explaining another example of a target program.

FIG. 10 is a diagram illustrating a functional configuration of a development system according to a third embodiment.

FIG. 11 is a diagram for explaining a configuration example of a computer system at which a development system according to a fourth embodiment targets as a program development target.

FIG. 12A is a diagram for explaining a problem of a byte-invariant method.

FIG. 12B is a diagram for explaining a problem of a word-invariant method.

FIG. 13 is a diagram for explaining a hardware configuration example of the development system according to the fourth embodiment.

FIG. 14 is a diagram for explaining a functional configuration of a development system according to the fourth embodiment.

FIG. 15 is a diagram for explaining an example of a data structure of write access information.

FIG. 16 is a flowchart for explaining an operation of the development system according to the fourth embodiment when a store instruction is executed.

FIG. 17 is a diagram for explaining an example of a data structure of write access information.

FIG. 18 is a flowchart for explaining an operation of the development system according to the fourth embodiment when a load instruction is executed.

FIG. 19 is a diagram for explaining a functional configuration of a development system according to a fifth embodiment.

FIG. 20 is a flowchart for explaining an operation of the development system according to the fifth embodiment when a load instruction is executed.

FIG. 21 is a flowchart illustrating a use method of a development system of a sixth embodiment.

FIG. 22 is a diagram for explaining a functional configuration of the development system of the sixth embodiment.

FIG. 23 is a diagram for explaining an example of a data structure of endian dependent information.

FIG. 24 is a flowchart for explaining an operation of the development system according to the sixth embodiment when a load instruction is executed in a first simulation.

FIG. 25 is a flowchart for explaining an operation of the development system according to the sixth embodiment when a load instruction is executed in a second or later simulation.

### DETAILED DESCRIPTION

According to one embodiment, a development system includes an instruction set simulator (ISS) and a checker. The ISS includes a central processing unit (CPU) model that executes a program by simulating the CPU and a memory model that functions as a work area of the CPU model. The checker monitors access instructions executed by the CPU model, which is included in the execution program, on the memory model and, when a difference between a data length at the time of writing and a data length at the time of reading on the same position (in the memory model) is detected, notifies the code being executed at the time of detection as an endian dependent code.

Exemplary embodiments of a development system will be explained below in detail with reference to the accompanying drawings. The present invention is not limited to the following embodiments.

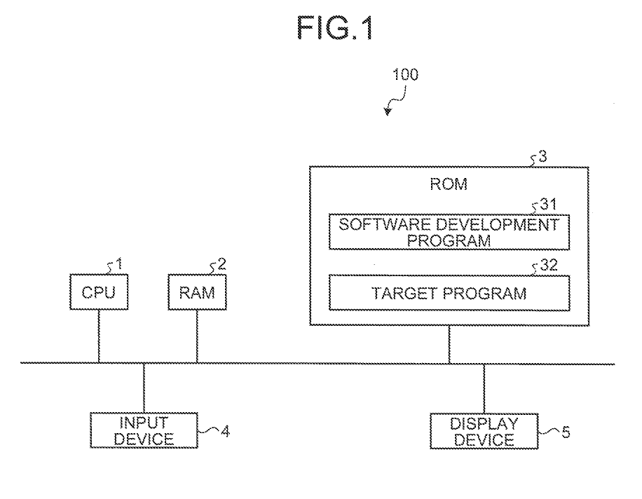

FIG. 1 is a block diagram illustrating a hardware configuration example of a development system according to a first embodiment of the present invention.

As illustrated in FIG. 1, a development system 100 is configured by a computer that includes a central processing unit (CPU) 1, a random access memory (RAM) 2, a read only memory (ROM) 3, an input device 4, and a display device 5. The CPU 1, the RAM 2, the ROM 3, the input device 4, and the display device 5 are connected to one another via a bus line.

The display device 5 is a display device such as a liquid crystal (LC) monitor and displays output information to be given to a user such as an operation screen based on an instruction from the CPU 1. The input device 4 is configured to include a mouse or a keyboard and receives the user's operation on the development system 100. Operation information input to the input device 4 is transmitted to the CPU 1.

The ROM 3 stores a target program 32 that is software (a compiled execution program) developed to target on a processor of a certain endian type and a software development program 31 that is a computer program for detecting an endian dependent code from the target program 32.

The term “endian” refers to the way in which data of multiple bytes is placed in each word in a memory, and most of current processors employ any one of a big endian type and a little endian type. In a case in which software accesses data on a memory, a start address of data and an access unit (a data length) are designated, and then access to the memory is performed. Here, if every access unit of every access to the same position on the memory is always the same, the software correctly operates regardless of the endian type of the processor. However, in a case in which access to the same position on the memory is performed in different units, if an endian type of a processor changes, a malfunction may be caused.

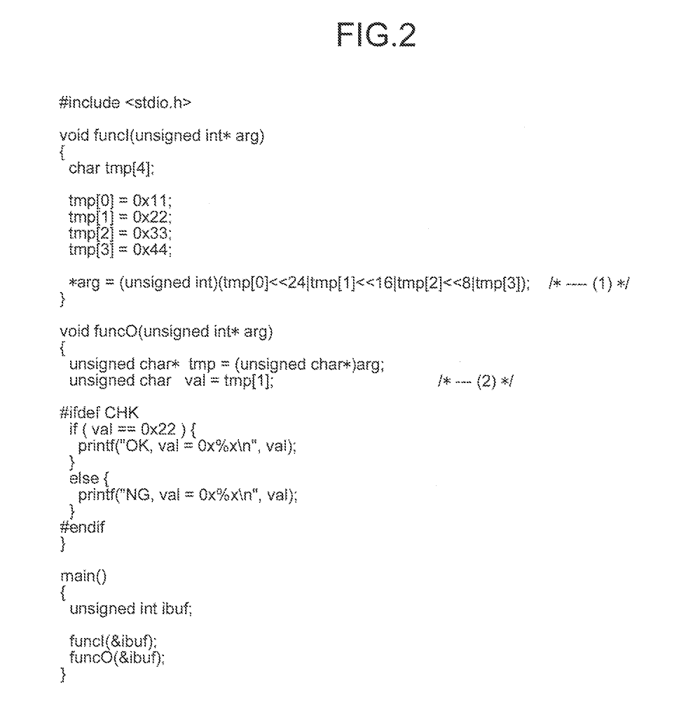

FIG. 2 is a diagram for explaining an example of the target program 32. The program targets on a big endian processor that regards 4 bytes (32 bits) as 1 word. In the program illustrated in FIG. 2, in a line of (1), data “tmp[0],” “tmp[1],” “tmp[2],” and “tmp[3]” of a byte (unsigned char) unit are written in an area of a word (unsigned int) unit pointed by a pointer “arg” with shifting a position to be written. In a line of (2), a second byte from an address pointed indicated by the pointer “arg” is read. In this program, in case of the big endian type, since in the line of (1), “0x22” is written in the second byte from an address pointed by the pointer “arg,” “0x22” is read in the line of (2), and thus an operation is correctly performed. However, in case of the little endian type, since “0x33” is written in the second byte from the address pointed by “arg” at the time of execution of the line of (1), an operation is not correctly performed.

The software development program 31 virtually executes (simulates) the target program 32 and monitors execution of access instructions to a memory. Further, when access to the same position on the memory is performed in different access units like memory access by (1) and (2) described above, the software development program 31 detects an instruction (a machine language) executed when the position is accessed as an endian dependent code.

The CPU 1 implements various functions, which will be described below, for detecting the endian dependent code by reading the software development program 31 from the ROM 3 according to the user's instruction input through the input device 4, loading the software development program 31 into a program storage area inside the RAM 2, and executing the software development program 31.

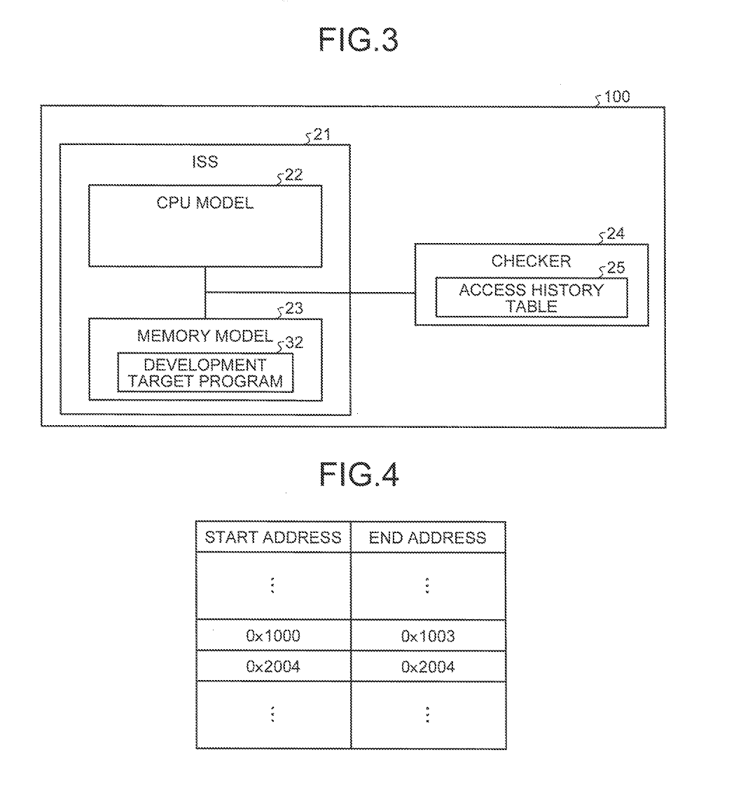

FIG. 3 is a block diagram for explaining a functional configuration of the development system 100. As illustrated in FIG. 3, the development system 100 includes an instruction set simulator (ISS) 21 that simulates an instruction set architecture of a target processor and a checker 24 that detects that an instruction executed by the ISS 21 is an instruction code that depends on an endian of the target processor.

The ISS 21 includes a CPU model 22 that simulates the behavior of the target processor of the target program 32 and a memory model 23 that simulates a main memory used by the target processor. At the time of simulation, the target program 32 is loaded into the memory model 23. The CPU model 22 allocates an area inside the memory model as a work area 23 and executes the target program 32 loaded into the memory model 23.

Further, in the first embodiment, the endian type of the target processor of the CPU model 22 is the same as the endian type of the target processor of the target program 32.

The checker 24 monitors instructions executed by the CPU model 22 and detects a difference between a data length at the time of writing and a data length at the time of reading on the same position. In further detail, when an instruction for writing data to the memory model 23 (a memory write instruction) is executed, the checker 24 registers an access range (area) of writing to an access history table 25. Further, when an instruction for reading data from the memory model 23 (a memory read instruction) is executed, the checker 24 retrieves the access history table 25 and judges whether or not an access range of the read access is the same access range as the access range of the write access to the same position registered to the access history table 25. If the access ranges are different, the checker 24 notifies the executed instruction as the endian dependent code. Here, the checker 24 outputs a report with regard to the endian dependent code to a file or the display device 5.

FIG. 4 is a diagram for explaining a data structure example of the access history table 25. As illustrated in FIG. 4, a start address and an end address of an area the date would be written are recorded for each occurrence of writing.

Since a local variable included in the target program 32 becomes invalid when the execution position of the program goes out of its scope, it is necessary to delete an address allocated to the local variable from the access history table 25. When the CPU model 22 executes an pop instruction, the checker 24 deletes an entry including a popped address from the access history table 25.

Further, the CPU model 22 sequentially fetches an instruction of an execution target to an instruction register included in the CPU model 22 and executes the instruction stored in the instruction register. Thus, the checker 24 preferably monitors execution of an instruction by monitoring the content of the instruction register. Further, by monitoring an address pointed by a program counter, execution of an instruction may be monitored. Further, when the stack is popped, an operation of a stack pointer included in the CPU model 22 is executed. The checker 22 may detect execution of the popped instruction by monitoring the stack pointer instead of monitoring the content of the instruction register or the address pointed by the stack pointer.

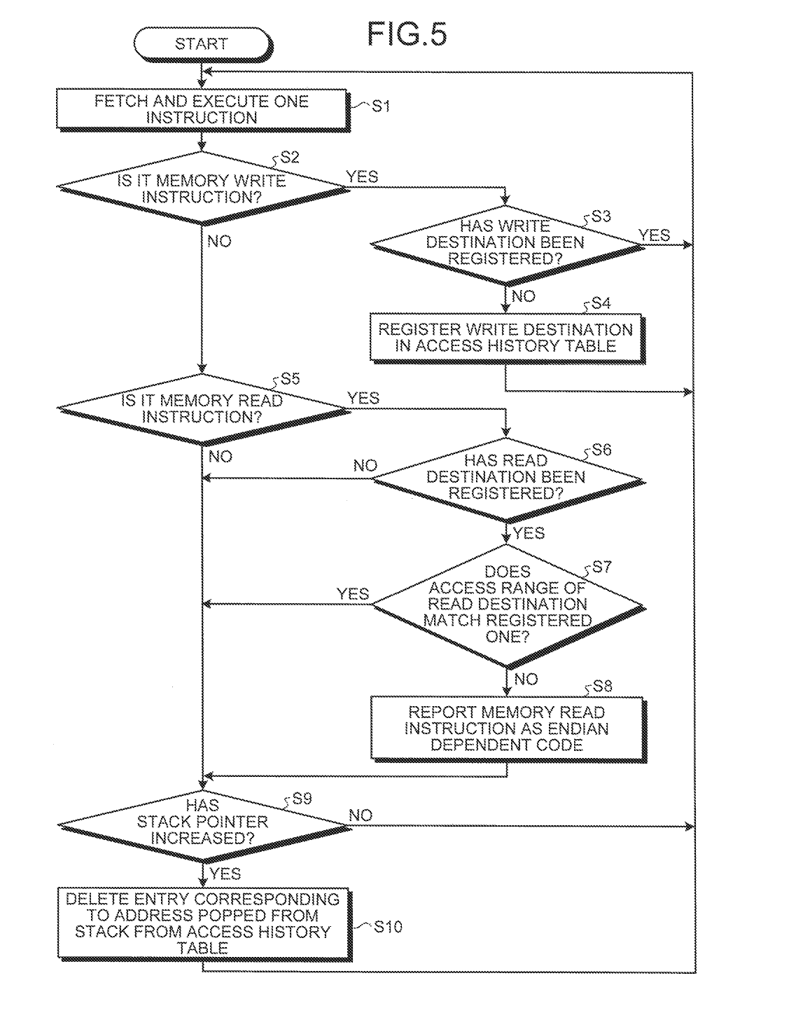

FIG. 5 is a flowchart for explaining an operation of the development system 100. Further, a description will be made using the program illustrated in FIG. 2 as an example of the target program 32. It is assumed that the target processors of the ISS 21 and the target program 32 employ the big endian type. Further, it is assumed that the target processor of the target program 32 regards 4 bytes (32 bits) as 1 word and has load/store instructions of a word unit and a byte unit. For example, a compiler generates the store instruction of the word unit from the line of (1) of FIG. 2 and generates the load/store instruction of the byte unit from the line of (2) of FIG. 2 since an 8-bit assignment is performed. Further, it is assumed that the stack grows towards lower addresses in the target processor. Further, it is assumed that the checker 24 monitors the stack pointer and detects execution of popping by detecting an increase in value of the stack pointer.

Once simulation of the target program 32 starts, the CPU model 22 sequentially executes instructions included in the target program 32 loaded into the memory model 23. As illustrated in FIG. 5, when the CPU model 22 fetches and executes one instruction (step S1), the checker 24 judges whether or not the execution instruction is a memory write instruction (step S2). The memory write instruction includes a push instruction as well as the store instruction. When it is judged that the executed instruction is the memory write instruction (Yes in step S2), the checker 24 further judges whether or not a write destination has previously been registered to the access history table 25 (step S3). When it is judged that the write destination has not previously been registered to the access history table 25 (No in step S3), the checker 24 registers the access range of the write destination to the access history table 25 (step S4) and proceeds to step S1. However, when it is judged that the write destination has previously been registered to the access history table 25 (Yes in step S3), step S4 is skipped, and the process proceeds to step S1.

When the line of (1) of the program of FIG. 2 is the execution position, the CPU model 22 executes the store word instruction. At this time, it is assumed that the pointer “arg” of the line of (1) is assigned to an address “0x1000” on the memory model 23. Here, access by the store instruction is word write access to “0x1000,” and an access range is “0x1000” to “0x1003.” In step S4, the checker 24 registers an entry in which a start address is “0x1000” and an end address is “0x1003” to the access history table 25. In the case of the write access of 1 byte, the start address is the same as the end address.

When it is judged in step S2 that the executed instruction is not the memory write instruction (No in step S2), the checker 24 judges whether or not the executed instruction is the memory read instruction (step S5). The memory read instruction includes a pop instruction as well as the load instruction. When it is judged that the executed instruction is the memory read instruction (Yes in step S5), the checker 24 further judges whether or not the access destination has previously been registered to the access history table 25 (step S6). When it is judged that the read destination has previously been registered to the access history table 25(Yes in step S6), the checker 24 further judges whether or not the access range of the read destination match the entry registered to the access history table 25 (step S7). The checker 24 outputs a report stating that the executed instruction is the endian dependent code (step S8) when it is judged that the access range of the read destination does not match with the entry registered to the access history table 25 (No in step S7).

When the line of (2) of the program of FIG. 2 is the execution part, the CPU model 22 executes the load instruction of the byte unit. At this time, since “tmp” points “0x1000” that is the same as “arg” and “tmp[1]” indicates a value stored in “0x1000,” it is the load instruction of the byte unit on “0x1001.” In this case, since “0x1000” to “0x1003” registered at the time of execution of the line of (1) overlaps the access destination “0x1001,” in step S6, the checker 24 judges that the read destination “0x1001” has been registered. Further, since the access range of the read destination is “0x1001” and the registered access range is “0x1000” to “0x1003,” in step S7, the checker 24 judges that the access range does not match, and in step S8, when the line of (2) in the target program 32 is the execution position, the executed load instruction is reported as the endian dependent part.

When it is judged in step S5 that the execution instruction is not the memory read instruction (No in step S5), the checker 24 judges whether or not a value of the stack pointer has increased (step S9). Here, when it is judged in step S6 that the read destination has not been registered (No in step S6), when it is judged in step S7 that the access range of the read destination does not match the registered entry (Yes in step S7), or after step S8, the process proceeds to step S9.

When it is judged that the value of the stack pointer has increased (Yes in step S9), the checker 24 deletes the entry corresponding to the popped address from the access history table 25 (step S10), and the process proceeds to step S1. However, when it is judged that the value of the stack pointer has not increased (No in step S9), step S10 is skipped, and the process proceeds to step S1.

Here, when the target program 32 of FIG. 2 first executes writing of the word unit and then executes reading of the byte unit, the executed instruction is detected as the endian dependent code. However, even when writing of the byte unit is executed before reading of the word unit is executed, the executed instruction is detected as the endian dependent code through the same procedure. The access unit is not limited to the word unit and the byte unit.

Since an immediate value in an operation code is directly stored in a register in the CPU model 22, it does not depend on the endian. Since the value is transmitted to the memory model 23 by the store instruction when the value is used, if it is the endian dependent code, it can be detected through the above described procedure. The endian dependent code using a local variable initialized a certain value, which is converted to an instruction with an immediate value can be detected through the above described procedure.

In the first embodiment, since the target program 32 and the CPU mode 22 employ the same endian type, the target program can be executed to the end, and thus the checker 24 can output all of the endian dependent codes on an execution path of the development program 32. Further, a user can perform porting to the program that targets on the processor of the different endian type (here, the little endian type) by revising the codes in reports.

In recent years, a tool that statically analyzes a program using a compiler or an assembler and detects the endian dependent code has been suggested. According to this tool, since the compiler or the assembler performs analysis in units of files, for example, when “funcO” and “main( )” included in the target program 32 of FIG. 2 are present in different files, it is difficult to detect that a code in “funcO” depends on the endian. In the first embodiment, since the target program 32 is dynamically analyzed by simulation, even if the target program 32 is divided into a plurality of files, the endian dependent codes can be detected.

The software development program 31 executed by the development system 100 of the first embodiment may be stored in a computer connected to a network such as the Internet and downloaded via the network for provision and distribution. Further, the software development program 31 may be supplied to, for example, the ROM 3 in advance for provision. Further, the software development program 31 may be stored in a CD-ROM or an external memory device for provision.

As described above, according to the first embodiment of the present invention, the ISS 21 including the CPU model 22 that simulates the target program 32 and the memory model 23 that functions as the work area of the CPU model 22, and the checker 24 that monitors execution of the access instruction (the memory write instruction and the memory read instruction), included in the target program 32, on the memory model 23 and, when the difference between the data length at the time of writing and the data length at the time of reading on the same spot is detected, notifies the execution position at the time of detection as the endian dependent code are provided. Thus, the endian dependent code included in the target program 32 can be detected.

Further, the checker 24 performs update management on the access history table 25 in which a write area is recorded for each memory write instruction on the memory model 23 and detects the difference between the data length at the time of writing and the data length at the time of reading on the same position based on the access history table 25. The checker 24 is configured to monitor an operation of the stack pointer by the CPU model 22 and delete the popped write area from the access history table 25 when popping of the stack is detected. Thus, each time of popping, an access history related to data pushed to the popped spot can be removed. Accordingly, the endian dependent spot related to the memory access on the stack spot can be detected.

The first embodiment has been described in connection with the case in which the target program and the CPU model employ the same endian type. A second embodiment will be described in connection with a case in which the target program and the CPU model employ different endian types. Since a hardware configuration of the development system of the second embodiment is the same as in the first embodiment, a description of the hardware configuration is omitted. The development system of the second embodiment is designated as 200 for distinction from the first embodiment.

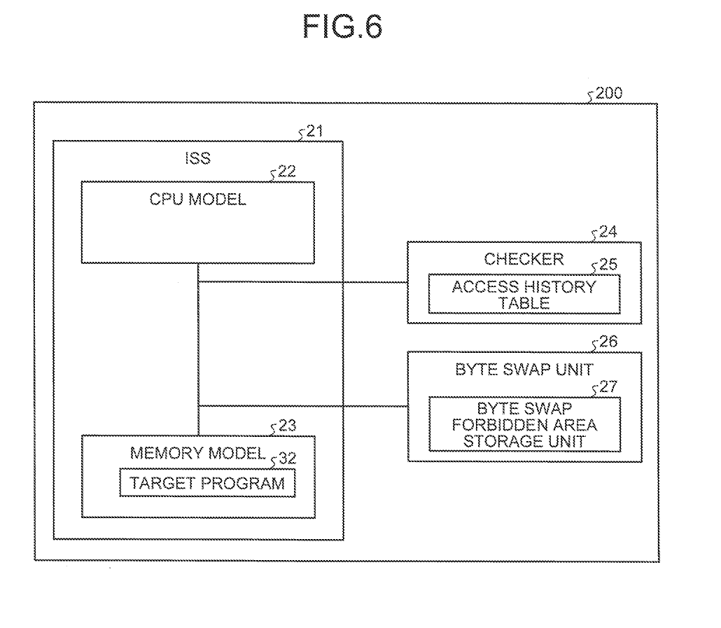

FIG. 6 is a diagram illustrating a functional configuration of the development system 200 according to the second embodiment. The same functional parts as in the first embodiment are denoted by the same reference numerals, and a detailed description thereof is omitted.

As illustrated in FIG. 6, the development system 200 includes the ISS 21 that has the CPU model 22 and the memory model 23, the checker 24 having the access history table 25, and a byte swap unit 26.

The byte swap unit 26 performs byte swap of each instruction executed by the CPU model 22. The byte swap unit 26 executes byte swap of access data (that is, byte swap in the access destination) when multi-byte access (multi-byte writing and multi-byte reading) such as access of the word unit is performed.

Further, in the case in which a hardware/resource other than the CPU such as an input/output (I/O) or a direct memory access controller (DMAC) has placed data of the little endian on the memory, if byte swap is performed, a malfunction occurs. However, the CPU has no means for knowing which endian type the data are. In order to avoid this situation, in the second embodiment, a byte swap forbidden area is given from the outside. The byte swap unit 26 includes a byte swap forbidden area storage unit 27 that stores the byte swap forbidden area.

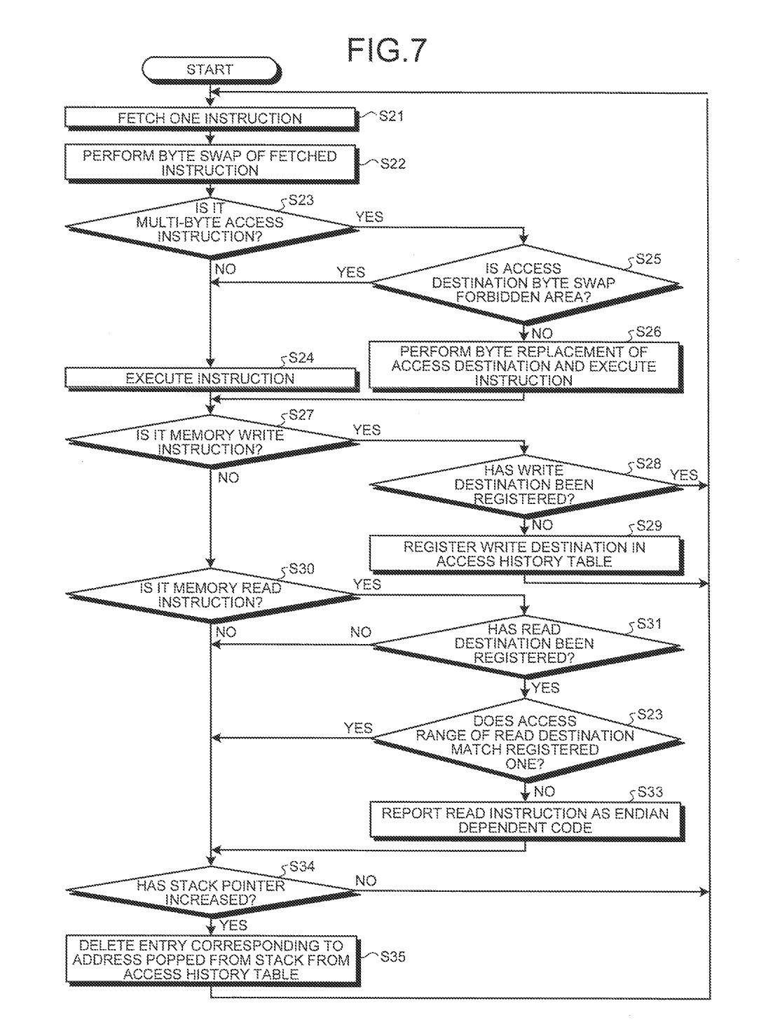

FIG. 7 is a flowchart for explaining an operation of the development system 200. As illustrated in FIG. 7, when the CPU model 22 fetches one instruction (step S21), the byte swap unit 26 performs byte swap on the instruction fetched by the CPU model 22 (step S22). The byte swap unit 26 judges whether or not the fetched instruction is a multi-byte access instruction (step S23).

When it is judged that the instruction is not the multi-byte access instruction (No in step S23), the CPU model 22 executes the instruction (step S24). However, when it is judged that the instruction is the multi-byte access instruction (Yes in step S23), the byte swap unit 26 further judges whether or not the access destination is the byte swap forbidden area (step S25). When it is judged that the access destination is the byte swap forbidden area (Yes in step S25), the process proceeds to step S24. However, when it is judged that the access destination is not the byte swap forbidden area (No in step S25), the byte swap unit 26 performs byte swap of the access destination, and the CPU 21 executes the instruction, so that the access destination on which byte swap has been performed is accessed (step S26).

After step S24 or after step S26, the checker 24 judges whether or not the execution instruction is the memory write instruction (step S27). When it is judged that the executed instruction is the memory write instruction (Yes in step S27), the checker 24 further judges whether or not the write destination has previously been registered to the access history table 25 (step S28). When it is judged that the write destination has not previously been registered to the access history table 25 (No in step S28), the checker 24 registers the access range of the write destination to the access history table 25 (step S29) and proceeds to step S21. However, when it is judged that the write destination has previously been registered to the access history table 25 (Yes in step S28), step S29 is skipped, and the process proceeds to step S1.

Meanwhile, when it is judged in step S27 that the executed instruction is not the memory write instruction (No in step S27), the checker 24 judges whether or not the executed instruction is the memory read instruction (step S30). When it is judged that the executed instruction is the memory read instruction (Yes in step S30), the checker 24 further judges whether or not the access destination has previously been registered to the access history table 25 (step S31). When it is judged that the read destination has previously been registered to the access history table 25 (Yes in step S31), the checker 24 further judges whether or not the access range of the read destination matches the entry registered to the access history table 25 (step S32). When it is judged that the access range of the read destination does not match the entry registered to the access history table 25 (No in step S32), the checker 24 produces a report saying the executed instruction is the endian dependent code and outputs it (step S33).

However, when it is judged in step S30 that the execution instruction is not the memory read instruction (No in step S30), the checker 24 judges whether or not the value of the stack pointer has increased (step S34). Here, when it is judged in step S31 that the read destination has not been registered (No in step S31), when it is judged in step S32 that the access range of the read destination is matched with the registered entry (Yes in step S32), or after in step S33, the memory read instruction is report-output as the endian dependent spot, the process proceeds to step S34.

When it is judged that the value of the stack pointer has increased (Yes in step S34), the checker 24 deletes the entry corresponding to the popped address from the access history table 25 (step S35), and the process proceeds to step S21. However, when it is judged that the value of the stack pointer has not increased (No in step S34), step S35 is skipped, and the process proceeds to step S21.

Further, whether to activate the byte swap function of the byte swap unit may be selected by the user's designation before simulation.

As described above, according to the second embodiment of the present invention, the byte swap unit performs byte swap on the instruction included in the target program 32, causes the CPU model 22 to execute the instruction, and, when the instruction executed by the CPU model 22 is the multi-byte access instruction, performs byte swap of the access destination at the time of execution of the multi-byte access instruction is further provided. Thus, when a compiler whose target CPU has the same endian type as the CPU model 22 cannot be obtained as a compiler for creating the target program 32 or when the CPU model 22 of the same endian type as a target CPU of a compiler that has created the target program 32 cannot be obtained, the target program 32 can be simulated to the end, and the endian dependent spot included in the target program 32 can be detected.

Further, since the byte swap forbidden area can be set to the memory model 23, even if there is memory writing from hardware resources other than the CPU, the target program 32 can be simulated as intended.

Further, writing data from hardware resources other than the CPU has not particularly been mentioned, but the user may provide writing data as an initial value. In this case, the user loads the initial value into the byte swap forbidden area in the memory model 23.

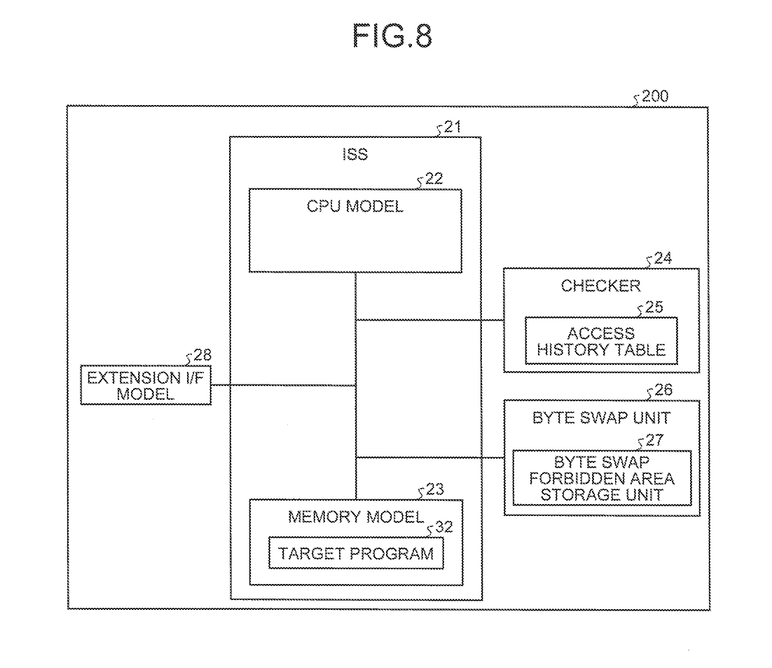

Further, a model for simulating an operation of the hardware resource other than the CPU may be added, and the hardware resource may operate without preparing for writing data from the resource as the initial value. FIG. 8 is a diagram for explaining a functional configuration of the development system 200 when the model for simulating an operation of the hardware resource is added. As illustrated in FIG. 8, an extension interface (I/F) model 28 simulates an operation of the hardware resources other than the CPU. The extension interface model 28 operates cooperatively with the CPU model 22 and appropriately performs access to the byte swap forbidden area.

According to the second embodiment, since fetching is performed according to the endian type of a target, the immediate value can properly be dealt as in the first embodiment.

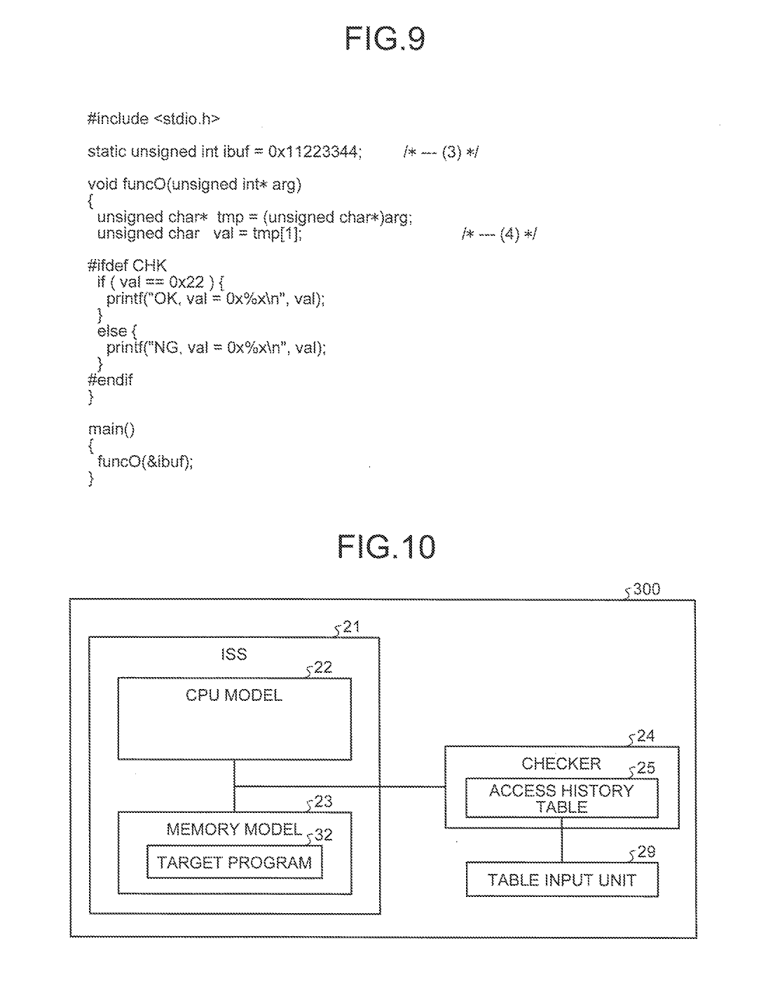

FIG. 9 is a diagram for explaining another example of a target program. As illustrated in FIG. 9, an initial value of a static variable is set in a line of (3). In a line of (4) included in “funcO” that is called from “main( )” reading of a second byte from the front of the initial value is performed.

The initial value is set to a memory by a pseudo instruction on an assembler such as “word” instruction. That is, the compiler creates a binary code not by transmitting such a numerical value by the store instruction but by placing data at an address mapped with a variable as an initial value of the memory from the beginning. Thus, it is difficult to discriminate whether the bit string is data or code only by looking at the target program that is the binary code in which symbol information is not included.

In a third embodiment, on the initial value (memory initial value data) set to the memory, information related to the memory initial value data can be input in the same form as the access history table.

A hardware configuration of a development system according to the third embodiment is the same as in the first embodiment, and thus a description of the hardware configuration is omitted. The development system of the third embodiment is designated as 200 for distinction from the first embodiment.

FIG. 10 is a diagram illustrating a functional configuration of the development system 300 according to the third embodiment. The same functional parts as in the first embodiment are denoted by the same reference numerals, and a detailed description thereof will be omitted. As illustrated in FIG. 10, the development system 300 includes the ISS 21 that has the CPU model 22 and the memory model 23, the checker 24 having the access history table 25, and a table input reception unit 29.

The user creates the access history table related to the memory initial value data in advance. For example, when a compiler and a linker assign the memory initial value to a certain area in the memory, it can output the information such as the length of the data and the address the data would be placed in, so the user may obtain those information by instructing the compiler or the linker, and create the access history table related to the memory initial value data using the output data length and the address. The user operates the input device 4 before starting the simulation of the target program 32 and inputs the created access history table through the external storage device (not shown).

The table input unit 29 receives an input of the access history table and registers the input access history table to the checker 24.

As described above, according to the third embodiment, since the access history table related to the initial value embedded in the binary code by the pseudo instruction can be registered, even if the memory initial value data exists, the endian dependent code can be detected by the same simulation operation as in the first embodiment.

The above description has been made in connection with the configuration in which the table input unit 29 is disposed in the development system of the first embodiment, but the table input unit 29 may be disposed in the development system of the second embodiment.

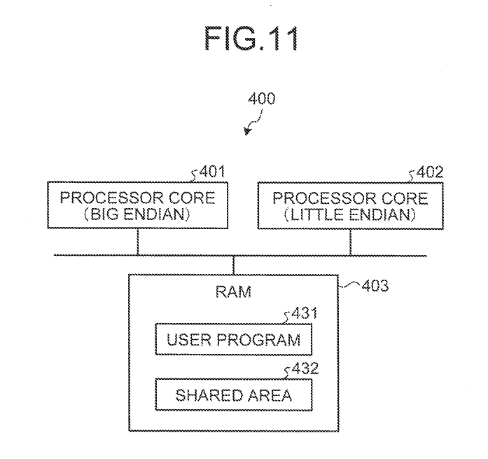

FIG. 11 is a diagram for explaining a configuration example of a computer system (hereinafter, referred to as simply “target system”) that a development system according to a fourth embodiment of the present invention targets on as a program development target.

As illustrated in FIG. 11, a target system 400 includes two processor cores 401 and 402 and a RAM 403. The respective components are connected to each other via a bus.

The endian type employed by the processor core 401 is different from the endian type employed by the processor core 403. In this example, it is assumed that the processor core 401 employs the big endian type, and the processor core 402 employs the little endian type.

A user program 431 that is a compiled execution program for operating the target system 400 is loaded into the RAM 403. The processor cores 401 and 402 execute the user program 431 to control an operation of the whole target system 400. The RAM 403 secures a work area used by the processor cores 401 and 402, and a part of the work area is used as a shared area 432 in which communication data (transmission data) between the processor cores 401 and 402 is placed. The processor cores 401 and 402 use the shared area 432 as a buffer memory and mutually execute data transmission. That is, the processor core of a transmission source temporarily store the transmission data in the shared area 432, and the processor core of a transmission destination reads the transmission data from the shared area 432.

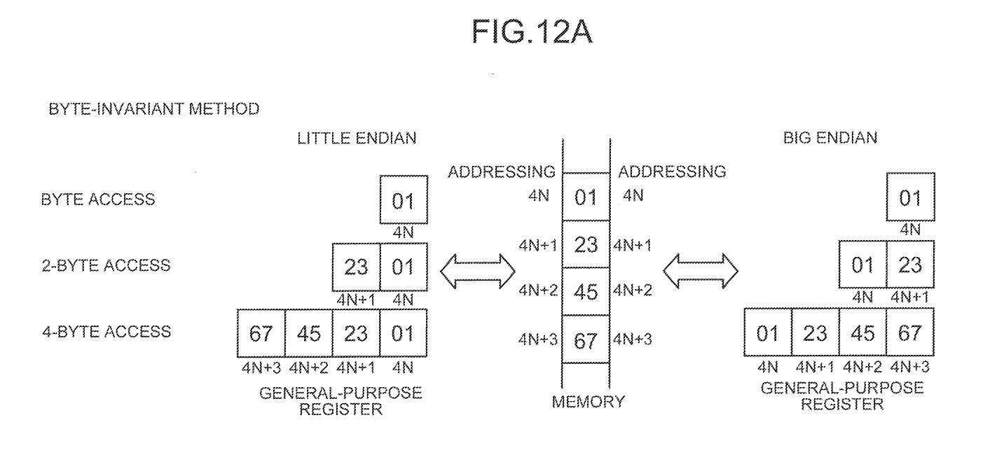

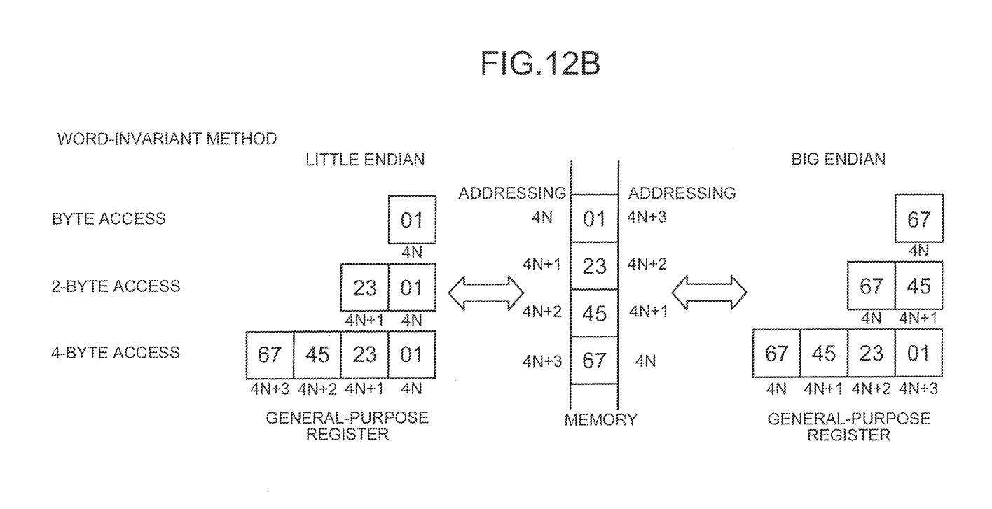

As a technique of performing data transmission between processor cores having different endian types through a memory, there are a byte-invariant method and a word-invariant method. FIGS. 12A and 12B are diagrams for explaining features of the two methods of performing data transmission.

In the byte-invariant method, a byte address is constant but a byte significance is reversed between big and little endian types.

As illustrated in FIG. 12A, it is assumed that 1 word is 4 bytes, that is data “0x01,” “0x23,” “0x45,” and “0x67” are stored in addresses “4N,” “4N+1,” “4N+2,” and “4N+3,” respectively. In the case of reading one-byte length data, even if the endian type is different, the same byte data can be read. However, in the case of reading multi-byte length data, there is a problem in that an order of byte data configured by read data becomes different according to the endian type.

For example, according to the big endian type, since loading or storing is performed so that the front of an address can be a most significant byte (MSB) of data, in the case of reading 4 bytes from the address “4N,” data “0x01234567” can be read. However, according to the little endian type, since loading or storing is performed so that the front of an address can be a least significant byte (LSB) of data, data “0x67452301” in which an order of read data in the big endian type is reversed is read. In the case of reading 2 bytes length data, similarly to the case of reading the 4 bytes length data, if the endian type changes, an order of read data is reversed. That is, according to the byte-invariant method, if data of a multi-byte length written by the processor core of the different endian type is read, data having a reversed order is read.

In the word-invariant method, the datum is a 4-byte word which always has the same value, independent of endianness. However, for accesses smaller than a 4-byte word, the address of the bytes are reversed between big and little endian types.

As illustrated in FIG. 12B, it is assumed that data “0x67452301” is stored in a memory. The processor core of the little endian type according to the word-invariant method performs address allocation in ascending order on the memory area like “4N,” “4N+1,” “4N+2,” and “4N+3.” Thus, when 4-byte word is loaded from the memory area, data “0x67452301” is read. Meanwhile, the processor core of the big endian type according to the word-invariant method performs address allocation in descending order like “4N+3,” “4N+2,” “4N+1,” and “4N.” Thus, when 4-byte word is loaded from the memory area, data “0x67452301” can be read as in the little endian type. However, according to the word-invariant method, since address allocation depends on the endian type, there is a problem in that when access is performed in a unit smaller than a 4-byte word like 1-byte length data or 2-byte length data, different data is accessed depending on the endian type.

As described above, even in the case in which any one of the byte-invariant method and the word-invariant method is employed, when transmission data is transferred between the processor cores 401 and 402, since transmission data before transmission is different from transmission data after transmission, intended data may not be transferred. In the fourth embodiment of the present invention, the target system 400 employs the byte-invariant method, simulates the user program 431, and detects an instruction (an endian dependent code) that causes a difference in transmission data between before and after transmission.

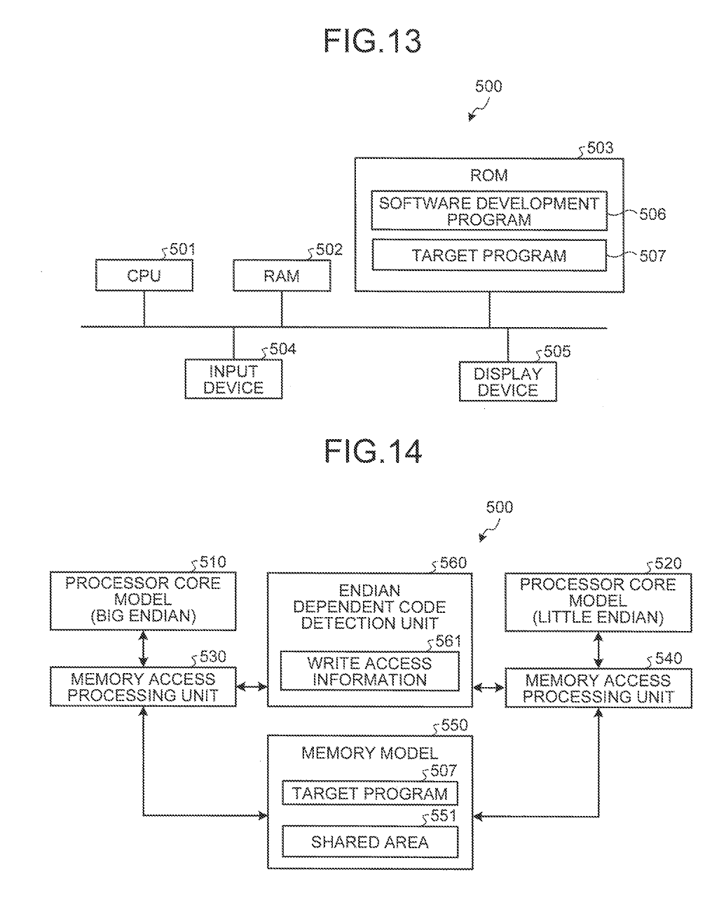

FIG. 13 is a diagram for explaining a hardware configuration example of the development system according to the fourth embodiment of the present invention. As illustrated in FIG. 13, a development system 500 includes a CPU 501, a RAM 502, a ROM 503, an input device 504, and a display device 505. The CPU 501, the RAM 502, the ROM 503, the input device 504, and the display device 505 are connected to one another via a bus line.

The display device 505 is a display device such as an LC monitor and displays output information on a user such as an operation screen based on an instruction from the CPU 501. The input device 504 is configured to include a mouse or a keyboard and receives an operation of the development system 500 from the user. Operation information input to the input device 504 is transmitted to the CPU 501.

The ROM 503 stores a target program 507 that is a user program 431 as a simulation execution target and a software development program 506 that is a computer program for detecting the endian dependent code from the target program 507

The CPU 501 implements various functions for detecting the endian dependent code by reading the software development program 506 from the ROM 503 according to the user's instruction input through the input device 504, loading the software development program 504 into a program storage area inside the RAM 502, and executing the software development program 504.

FIG. 14 is a diagram for explaining a functional configuration of a development system 500 according to the fourth embodiment. As illustrated in FIG. 14, the development system 500 includes a processor core model 510, a processor core model 520, a memory access processing unit 530, a memory access processing unit 540, a memory model 550, and an endian dependent code detection unit 560.

The processor core models 510 and 520 are ones in which functions of the processor cores 401 and 402 are modeled, respectively, and can simulate operations of the processor cores 401 and 402, respectively. The processor core model 510 performs memory access according to the big endian type, and the process core model 520 performs memory access according to the little endian type. The memory model 550 is one in which the RAM 403 is modeled. The target program 507 is loaded into the memory model 550, and each of the processor core models 510 and 502 fetches and executes a corresponding instruction included in the target program 507 based on a its program counter. A work area used by the processor core models 510 and 520 at the time of execution of the simulation is secured in the memory model 550, and a part of the work area is used as a shared area (designated as 551 in FIG. 14). The processor core models 510 and 520 and the memory model 550 may be implemented by hardware, for example, by preparing actual equipment of the target system 400.

The memory access processing unit 530 is interposed between the processor core model 510 and the memory model 550, and the processor core model 510 performs memory access to the memory model 550 through the memory access processing unit 530. Specifically, the memory access processing unit 530 receives write data (only at the time of execution of the store instruction), an access destination address, and a data byte length of an access target (hereinafter, a memory access request), which are issued at the time of execution of load/store instruction and performs a read/write operation on the memory model 550 in response to the received memory access request according to the byte-invariant method and the big endian type. The memory access processing unit 530 notifies the endian dependent code detection unit 560 of the content of the received memory access request and the endian type “big endian” of the processor core model of a memory access request issuing source.

As described above, according to the byte-invariant method, when multibyte data is read from the address at which data is written from the processor core having a different endian type, an order of bytes that configure the read multibyte data is reversed. When the processor core model 510 reads transmission data from the processor core model 520, the memory access processing unit 530 functions as a conversion processing unit that obtains transmission data of a state before transmission by reversing an order of the read multibyte data so that the simulation of the target program 507 can be continued using the transmission data as intended. The memory access processing unit 530 transfers data obtained by the conversion to the processor core model 510.

The memory access processing unit 540 is interposed between the processor core model 520 and the memory model 550. The memory access processing unit 540 receives a memory access request from the processor core model 520 and executes a read/write operation on the memory model 550 in response to the received memory access request according to the byte-invariant method and the little endian type. The memory access processing unit 540 notifies the endian dependent code detection unit 560 of the content of the received memory access request and the endian type “little endian” of the processor core model of a memory access request issuing source. When multibyte data is read, the memory access processing unit 540 functions as a conversion processing unit that obtains transmission data of a state before transmission by reversing an order of the data.

The endian dependent code detection unit 560 detects the endian dependent code based on the notices from the memory access processing units 530 and 540. In further detail, the endian dependent code detection unit 560 manages write access information 561 in which a write destination address and an endian type of the processor core model of a writing source are recorded for each write data and judges whether or not the load instruction is the endian dependent code, based on the write access information 561 and the read size of the load instruction. When the endian dependent code is detected, the endian dependent code detection unit 560 notifies a corresponding one of the memory access processing units 530 and 540 of detection of the endian dependent code.

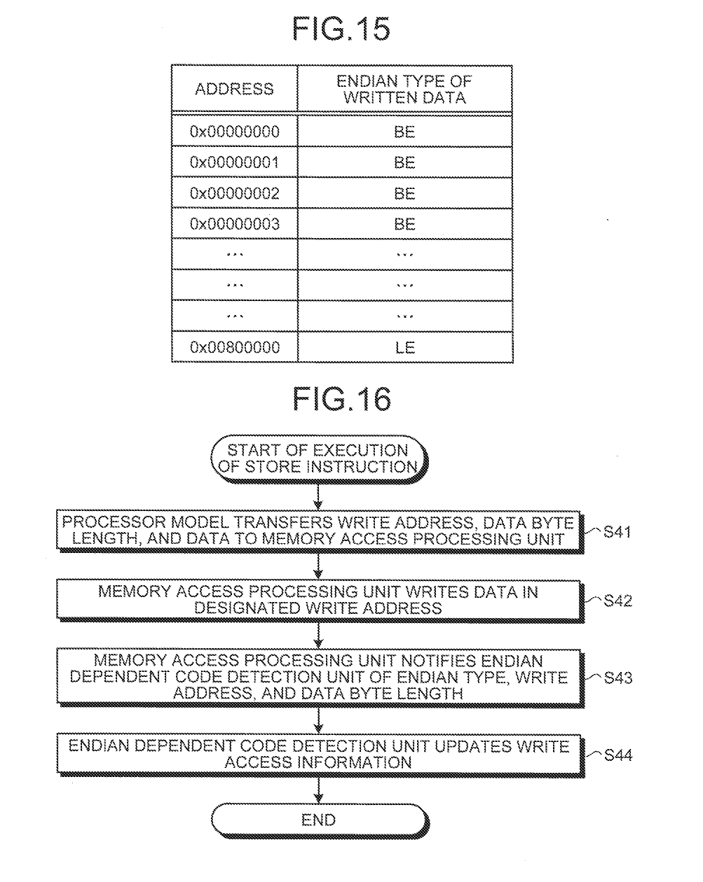

FIG. 15 is a diagram for explaining an example of a data structure of the write access information 561. As illustrated in FIG. 15, an address and an endian type of the processor core model of the writing source are recorded in the write access information 561 for each byte.

When the notice representing that the endian dependent code has been detected is received from the endian dependent code detection unit 560, the memory access processing units 530 and 540 function as an endian dependent code notification unit that notifies the user of the corresponding load instruction as the endian dependent code. Here, it is assumed that as an example of the notice to the user, a report output is performed. The output report may be displayed on the display device 505 or may be stored in the RAM 502 or an external storage device (not shown) as a file.

Next, an operation of the development system 500 according to the fourth embodiment of the present invention will be described. If the simulation starts, the processor core models 510 and 520 sequentially fetch instructions from the target program 507, decode the fetched instructions, and execute the instructions. FIG. 16 is a flowchart for explaining an operation of the development system 500 when the store instruction is executed. Here, as an example, a description will be made in connection with a case in which the processor core model 510 is an execution source of the store instruction.

As illustrated in FIG. 16, if the store instruction is executed, the processor core model 510 first transfers a write access request including a write address, a data byte length, and write data to the memory access processing unit 530 (step S41). The memory access processing unit 530 writes the write data in the write address of the memory model 550 designated by the write access request (step S42). The memory access processing unit 530 notifies the endian dependent code detection unit 560 of the endian type “big endian (BE)” of the processor core model 510, the write address, and the data byte length (step S43). The endian dependent code detection unit 560 updates the write access information 561 by writing a record, which causes an address of a range corresponding to the data byte length from the received write address to be “BE,” in the write access information 561 (step S44), and an operation of writing data in the memory model 550 is finished.

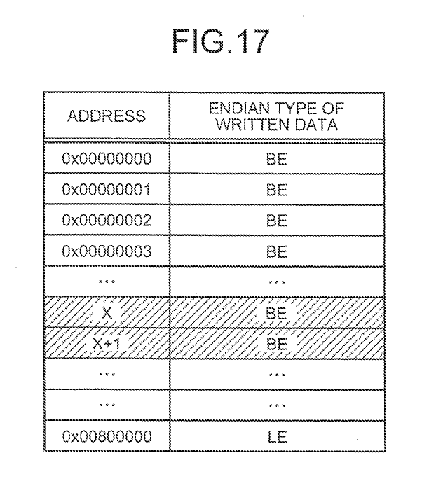

For example, let us assume that the processor core model 510 issues the write access request including the write address “X,” the data byte length “2,” and the write data “0x1234.” In this case, as in the example of the write access information 561 illustrated in FIG. 17, the endian dependent detection unit 560 registers an entry representing that the address is “X” and the endian type is “BE” and an entry representing that the address is “X+1” and the endian type is “BE” to the write access information 561. Further, when an entry having the same address has already been registered, the endian dependent detection unit 560 overwrites an entry of a corresponding address.

The write data by the store instruction includes temporary data used by the processor core model 510 as well as transmission data to be transmitted to the processor core model 520 written in the shared area 551. Further, an entry related to temporary data that has not been transmitted as well as an entry related to transmission data is registered to the write access information 561.

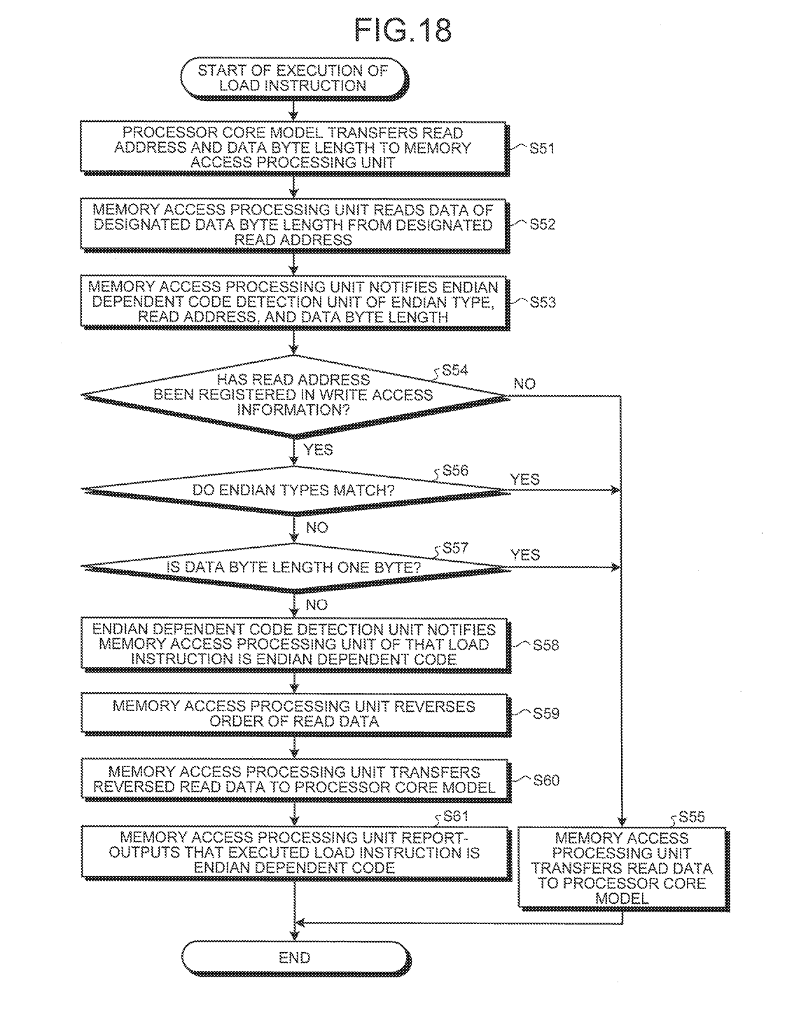

FIG. 18 is a flowchart for explaining an operation of the development system 500 when the load instruction is executed. Here, as an example, a description will be made in connection with a case in which the processor core model 520 is an execution source of the load instruction.

First, if the load instruction is executed, the processor core model 520 transfers a read access request including a read address and a data byte length to the memory access processing unit 540 (step S51). The memory access processing unit 540 reads data designated by the data byte length from the position designated by the read address in the memory model 550 (step S52). The memory access processing unit 540 notifies the endian dependent code detection unit 560 of the endian type “little endian (LE)” of the processor core model 520, the read address, and the data byte length (step S53).

The endian dependent code detection unit 560 judges whether or not the read address has been registered to the write access information 561 by retrieving the write access information 561 using the designated read address as a retrieval key (step S54). If the data byte length represents multiple bytes, the endian dependent code detection unit 560 retrieves each byte data that configures the read data by using an address of each one byte of the read destination as a retrieval key. If even one of addresses of the read destination of multiple bytes has been registered, the an-dependent code detection unit 560 judges that the read address has been registered (Yes in step S54), whereas if any address has not been registered, the an-dependent code detection unit 560 judges that the read address has not been registered (No in step S54).

When it is judges that the read address has not been registered to the write access information 561 (No in step S54), the memory access processing unit 540 transfers the read data to the processor core model 520 (step S55), and an operation related to reading from the memory model 550 is finished.

When it is judges that the read address has been registered to the write access information 561 (Yes in step S54), the endian dependent code detection unit 560 judges whether or not the endian type (here, the little endian type) of the processor core model 520 that has issued the read access request matches the registered endian type (step S56). When it is judged as matched (Yes in step S56), it means that the executed load instruction is an instruction that causes the processor core mode 520 to read temporary data or transmission data in which the processor core model 520 is the transmission source by the processor core model 520 itself and not the endian dependent code, and thus the process proceeds to step S55.

When it is judged that the endian type of the processor core model 520 that has requested the read access does not match the registered endian type (No in step S56), the processor core model 510 is the transmission source, and the read target of the load instruction is transmission data written in the shared area 551. The endian dependent code detection unit 560 further judges whether or not the data byte length of the read target of the executed load instruction is one byte (step S57). When it is judged that the data byte length is one byte (Yes in step S57), the process proceeds to step S55.

When it is judged that the data byte length is not one byte (No in step S57), the endian dependent code detection unit 560 judges the load instruction as the endian dependent code and notifies of the memory access processing unit 540 of the fact that the load instruction is the endian dependent code (step S58). When the notice is received, the memory access processing unit 540 reverses an order of the read data (step S59) and transfers the reversed read data to the processor core model 520 (step S60). The memory access processing unit 540 report-outputs that the executed load instruction is the endian dependent code (step S61), and the execution process of the load instruction is finished.

For example, if it is assumed that the processor core model 520 has issued the read access request including the read address “X” and the data byte length “2,” the memory access processing unit 540 reads data “0x3412” from the read address “X.” The data “0x3412” is different from the data “0x1234” before transmission, and so if the processor core model 520 continues the simulation using the data, an error occurs. The endian dependent code detection unit 560 retrieves the write access information 561 illustrated in FIG. 17 using the addresses “X” and “X+1” as a retrieval key. In the write access information 561, the big endian that is different from the endian type of the processor core model 520 has been registered to both addresses, and the data byte length is “2.” Thus, the endian dependent code detection unit 560 detects the corresponding load instruction as the endian dependent code. The memory access processing unit 540 changes the order of the data “0x3412” to obtain the data “0x1234” before transmission and transfers “0x1234” to the processor core model 520 as the read data. The processor core model 520 can continue the simulation using the data “0x1234” as intended.

As described above, according to the fourth embodiment of the present invention, provided are the two processor core models 510 and 520 that simulate the operations of the two processor cores 401 and 402 that are different in endian type, respectively, the memory model 550 that simulates the RAM 403 used for data transmission between the processor cores 401 and 402, the endian dependent code detection unit 560 that judges whether or not the load instruction is the endian dependent code, based on the read size of the load instruction, when the load instruction that causes the data transmission destination processor core model of the two processor core models 510 and 520 to read transmission data written in the memory model 550 is executed, and the memory access processing units 530 and 540 (the endian dependent code notification units) that notifies of the user of the fact that the load instruction is the endian dependent code when the endian dependent code detection unit 560 has judged that the load instruction is the endian dependent code. Thus, the endian dependent code can be detected from the program that targets on the target system 400 including the two processor cores that are different in endian type.

When the endian dependent code detection unit 560 has judged that the load instruction is the endian dependent code, the memory access processing units (the conversion processing units) 530 and 540 obtain corresponding transmission data before transmission and transfers the obtained transmission data before transmission to the data transmission destination processor core model. Thus, since the transmission destination processor core model can read intended data, even after the endian dependent code is executed and so the endian dependent code is detected, the simulation can be continued as intended.

The endian dependent code detection unit 560 is configured to judge a load instruction whose read size is multiple bytes among load instructions that cause the data transmission destination processor core model to read the transmission data as the endian dependent code. Thus, when the target system 400 employs the byte-invariant method, the endian dependent code can be detected from the program that targets on the target system 400 including the two processor cores that are different in endian type.

Further, the memory access processing units 530 and 540 is configured to obtain the transmission data before transmission by reading multi-byte data designated from the read address designated by the load instruction judged as the endian dependent code according to the endian type of the data transmission destination processor core model and reversing an order of each byte data that configures the read multi-byte data.

In a fifth embodiment, the endian dependent code is detected from a program that operates by the target system 400 employing the word-invariant method. A hardware configuration of a development system of a fifth embodiment is the same as in the fourth embodiment, and a description thereof is omitted. The development system of the fifth embodiment is designated as 600 for distinction from the first embodiment.

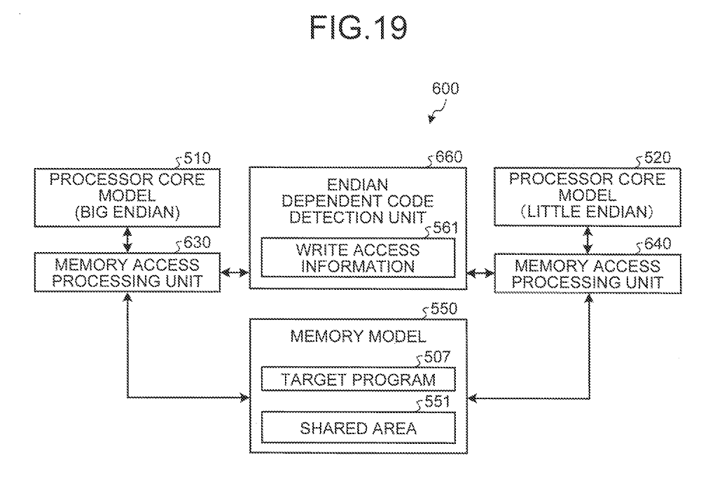

FIG. 19 is a diagram for explaining a function configuration of the development system 600 according to the fifth embodiment. The same components as in the fourth embodiment are denoted by the same reference numerals, and a detailed description thereof is omitted.

As illustrated in FIG. 19, the development system 600 includes a processor core model 510, a processor core model 520, a memory access processing unit 630, a memory access processing unit 640, a memory model 550, and an endian dependent code detection unit 660. The target program 507 is loaded into the memory model 550. In the memory model 550, the shared area 551 that the processor core models 510 and 520 use as a data transmission buffer is secured. The processor core models 510 and 520 and the memory model 550 may be implemented by hardware, for example, by preparing actual equipment of the target system 400.

The memory access processing unit 630 is interposed between the processor core model 510 and the memory model 550. When the memory access request is received from the processor core model 510, the memory access processing unit 630 performs the read/write operation on the memory model 550 in response to the received memory access request according to the word-invariant method and the big endian type. The memory access processing unit 630 notifies the endian dependent code detection unit 660 of the content of the received memory access request and the endian type “big endian” of the processor core model of the memory access request issuing source.

As described above, according to the word-invariant method, since address allocation inside an area that configures 1 word becomes different depending on the endian type. For this reason, if it is attempted to read data of a unit smaller than a word from an address in which data is written from a processor core having a different endian type, intended data cannot be read. In order for the processor core model 510 to continue the simulation of the target program 507 using the read data as intended, the memory access processing unit 630 functions as the conversion processing unit that converts the read address when reading data of the data byte length smaller than 1 word from an address written from the processor core model 520.

The memory access processing unit 640 is interposed between the processor core model 520 and the memory model 550. When the memory access request is received from the processor core model 520, the memory access processing unit 640 performs the read/write operation on the memory model 550 in response to the received memory access request according to the word-invariant method and the little endian type. The memory access processing unit 640 notifies the endian dependent code detection unit 660 of the content of the received memory access request and the endian type “little endian” of the processor core model of the memory access request issuing source. Further, the memory access processing unit 640 functions as the conversion processing unit that converts the read address when reading data of the data byte length smaller than 1 word from an address written from the processor core model 520.

The endian dependent code detection unit 660 detects the endian dependent code based on the notices from the memory access processing units 630 and 640. Specifically, the endian dependent code detection unit 660 manages the write access information 561 and judges whether or not the load instruction is the endian dependent code, based on the write access information 561 and the read size of the load instruction. When the endian dependent code is detected, the endian dependent code detection unit 660 notifies the corresponding memory access processing unit of detection of the endian dependent code.

When the notice representing that the endian dependent code has been detected is received from the endian dependent code detection unit 660, the memory access processing units 630 and 640 function as the endian dependent code notification unit that notifies the user of the corresponding load instruction as the endian dependent code.

Next, an operation of the development system 600 according to the fifth embodiment of the present invention will be described. If the simulation starts, the processor core models 510 and 520 sequentially fetch instructions from the target program 507, decode the fetched instructions, and execute the instructions.

When the processor core model 510 and 520 execute the store instruction, the respective components of the fifth embodiment execute the same operation as the components having the same name of the fourth embodiment, and a description thereof is omitted.

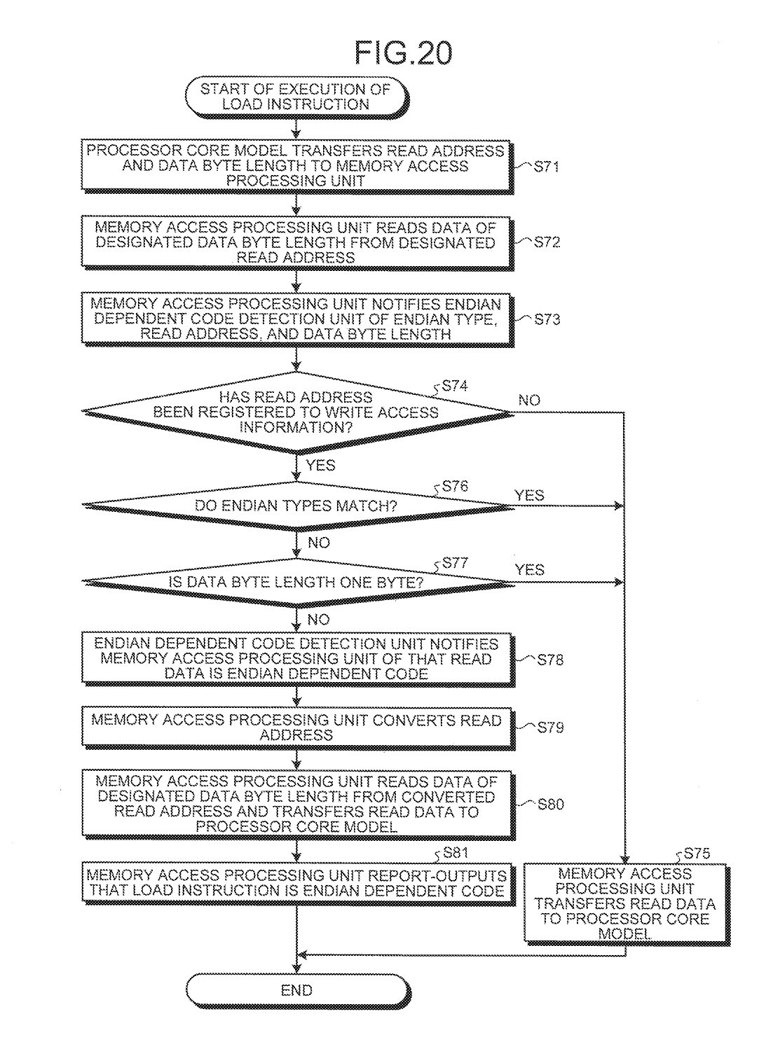

FIG. 20 is a flowchart for explaining an operation of the development system 600 when the load instruction is executed. A description will be made in connection with a case in which the processor core model 520 is an execution source of the load instruction.

First, when the load instruction is executed, the processor core model 520 first transfers a read access request including a read address and a data byte length to the memory access processing unit 640 (step S71). The memory access processing unit 640 reads data designated by the data byte length from the position designated by the read address in the memory model 550 (step S72). The memory access processing unit 640 notifies the endian dependent code detection unit 660 of the endian type “LE” of the processor core model 520, the read address, and the data byte length (step S73).

The endian dependent code detection unit 660 judges whether or not the address of the read destination has been registered to the write access information 561 by retrieving the write access information 561 using the designated read address as a retrieval key (step S74). If the data byte length represents multiple bytes, the endian dependent code detection unit 660 retrieves each byte data that configures the read data by using an address of each one byte of the read destination as a retrieval key as in the fourth embodiment.

When it is judges that the read address has not been registered to the write access information 561 (No in step S74), the memory access processing unit 640 transfers the read data to the processor core model 520 (step S75), and the operation when the load instruction is executed is finished.

When it is judges that the read address has been registered to the write access information 561 (Yes in step S74), the an-dependent code detection unit 660 judges whether or not the endian type “little endian” of the processor core model 520 that has issued the read access request matches the registered endian type (step S76). When it is judged as matched (Yes in step S76), the process proceeds to step S75.

When it is judged that the endian type of the processor core model 520 that has requested the read access does not match the registered endian type (No in step S76), the endian dependent code detection unit 660 further judges whether or not the data byte length is one byte (step S77). When it is judged that the data byte length is one byte (Yes in step S77), the load instruction is not the endian dependent code, and thus the process proceeds to step S75.

When it is judged that the data byte length is not one byte (No in step S77), the endian dependent code detection unit 760 judges the read data as the endian dependent code and notifies of the memory access processing unit 640 of the fact that the read data is the endian dependent code (step S78). When the notice is received, the memory access processing unit 640 reverses lower 2 bits of the read address (step S79). The memory access processing unit 640 reads data of the data byte length designated from the converted read address and transfers the read data to the processor core model 520 (step S80). The memory access processing unit 640 report-outputs that the executed load instruction that causes the read access request in the target program 507 is the endian dependent code (step S81), and the operation when the load instruction is executed is finished.

For example, let us assumed that the processor core model 510 has written data “0x12345678” in a write address “Y” and the processor core model 520 has issued a read access request including a read address “Y” and a data byte length “1,” the memory access processing unit 640 reads data “0x21” from the write address “Y.” The data “0x21” is not data intended by the processor core model 520, and if the processor core model 520 continues the simulation using the data, an error occurs. The endian dependent code detection unit 660 retrieves the load instruction that causes the read access request to be issued as the endian dependent code, reads data “0x78” from an address “Ŷ3” in which lower 2 bits of the read address “Y” is reversed, and transfers the read data “0x78” to the processor core model 520 as the read data. The processor core model 520 can continue the simulation using the data “0x78” as intended.

As described above, according to the fifth embodiment of the present invention, the endian dependent detection unit 660 is configured to judge the load instruction whose read size is less than a word among load instructions that cause the processor core model of the data transmission destination to read the transmission data. Thus, when the target system 400 employs the word-invariant method, the endian dependent code can be detected from the program that targets on the target system 400 including the two processor cores that are different in endian type.

The memory access processing units 630 and 640 are configured to convert the read address designated by the load instruction to the address allocated by the processor core model of the transmission source and read the transmission data according to the endian type of the processor core model of the transmission destination. Thus, the endian dependent code can be executed, and even after the endian dependent code is detected, the simulation can be continued as intended.

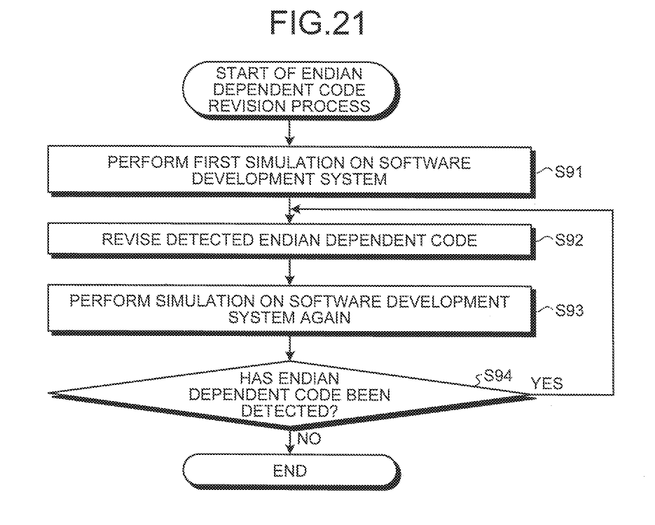

First, a basic use method of a development system of a sixth embodiment will be described. FIG. 21 is a flowchart illustrating a use method of the development system of a sixth embodiment. The development system of a sixth embodiment is designated as 700 for distinction from the fourth and fifth embodiments.

As illustrated in FIG. 21, the user first simulates the target program 507 on the development system 700 and detects all of the endian dependent codes included in the target program 507 (step S91). Here, a read address and read data at the time of execution of the endian dependent code detected in step S91 are recorded and kept in the development system 700.

The user revises the detected endian dependent code (step S92) and executes detection of the endian dependent code again using the development system 700 (step S93). In step S93, the development system 700 filters and detects only the endian dependent code that is not revised in step S92 using the read recorded address and the read data.

The user judges whether or not the endian dependent code has been detected (step S94). When it is judged that the endian dependent code has been detected (Yes in step S94), the process proceeds to step S92 and performs further revision. However, when it is judged that the endian dependent code has not been detected (No in step S94), it means that all of the endian dependent codes have been revised, and so a process of revising the endian dependent code is finished.

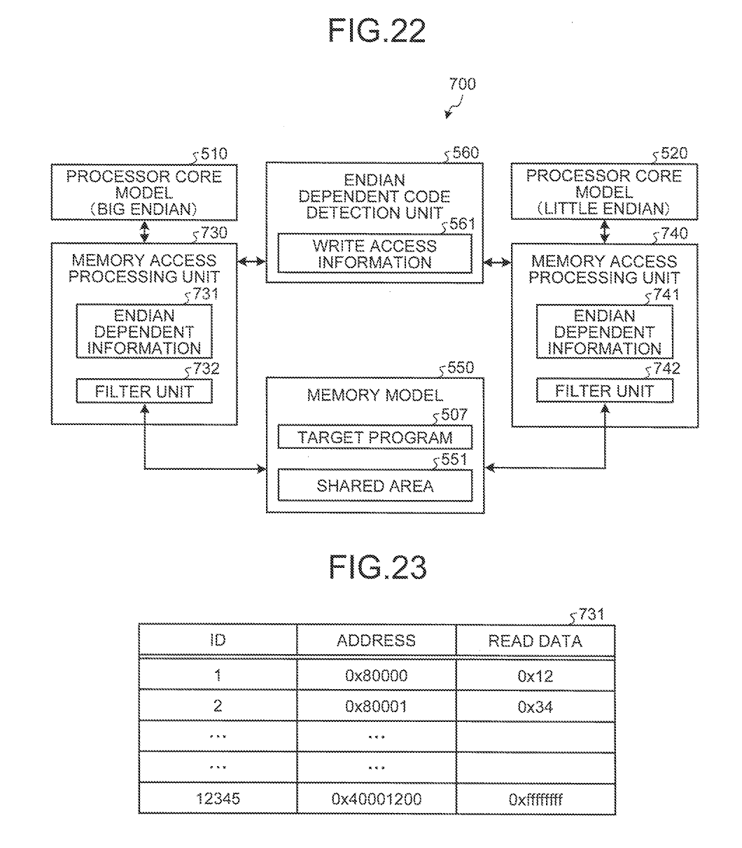

FIG. 22 is a diagram for explaining a functional configuration of the development system 700 of the sixth embodiment for executing the above described use method. A description will be made in connection with a case in which the target system 400 employs the byte-invariant method similarly to the case of the fourth embodiment. A hardware configuration of the development system 700 is the same as in the fourth embodiment, and thus a description thereof is omitted. The same components as in the fourth embodiment are denoted by the same reference numerals, and a detailed description thereof is omitted.

As illustrated in FIG. 22, the development system 700 includes a processor core model 510, a processor core model 520, a memory access processing unit 730, a memory access processing unit 740, a memory model 550, and an endian dependent code detection unit 560. The target program 507 is loaded into the memory model 550. In the memory model 550, the shared area 551 that the processor core models 510 and 520 use as a data transmission buffer is secured. The endian dependent code detection unit 560 includes the write access information 561. The processor core models 510 and 520 and the memory model 550 may be implemented by hardware, for example, by preparing actual equipment of the target system 400.

The memory access processing unit 730 is interposed between the processor core model 510 and the memory model 550, and the processor core model 510 performs memory access to the memory model 550 through the memory access processing unit 730. Specifically, the memory access processing unit 730 receives the memory access request from the processor core model 510 and executes the read/write operation on the memory model 550 in response to the received memory access request according to the byte-invariant method and the little endian type. The memory access processing unit 730 notifies the endian dependent code detection unit 560 of the content of the received memory access request and the endian type “big endian” of the processor core model of the memory access request issuing source. When the processor core model 520 reads the transmission data from the processor core model 520, the memory access processing unit 730 functions as the conversion processing unit that obtains transmission data of a state before transmission by reversing an order of the read multibyte data.

The memory access processing unit 730 further includes an endian dependent information 731 and a filter unit 732. The endian dependent information 731 is information in which the read address related to the load instruction judged as the endian dependent code and the read data whose order is changed by byte swap are time-sequentially accumulated and recorded as a pair.

FIG. 23 is a diagram for explaining an example of a data structure of the endian dependent information 731. As illustrated in FIG. 23, the endian dependent information 731 has a data structure of a table form in which entries including an address and revised read data are registered in an order in which the endian dependent code is detected. An ID of each entry represents a registered order. In the endian dependent information 731, since it is preferable to manage each entry time-sequentially, a time (a cycle time) may be used instead of an ID.

In second or later simulation, regardless of whether or not revision has been made by the user, the endian dependent code detection unit 560 detects the load instruction, which has been detected as the endian dependent code in the first simulation, as the endian dependent code in the same order as in the first simulation. When a notice representing the endian dependent code has been detected at the time of the second or later simulation is received from the endian dependent code detection unit 560, the filter unit 732 excludes the endian dependent code previously revised by the user from a notification target based on a comparison between the read data when detected as the endian dependent code and the revised read data recorded in a corresponding entry registered to the endian dependent information 731. The memory access processing unit 730 report-outputs the endian dependent codes remaining after exclusion by the filter unit 732.

The memory access processing unit 740 is interposed between the processor core model 520 and the memory model 550, and the processor core model 520 performs memory access to the memory model 550 through the memory access processing unit 740. The memory access processing unit 740 includes an endian dependent information 741 and a filter unit 742. The endian dependent information 741 and the filter unit 742 target on different processor core models but execute the same operations as the endian dependent information 731 and the filter unit 732 included in the memory access processing unit 730, respectively.

Next, an operation of the development system 700 according to the sixth embodiment of the present invention will be described. If the simulation starts, the processor core models 510 and 520 sequentially fetch instructions from the target program 507, decode the fetched instructions, and execute the instructions.

When the processor core model 510 and 520 execute the store instruction, the respective components of the sixth embodiment execute the same operation as the components having the same name of the fourth embodiment, and a description thereof is omitted.

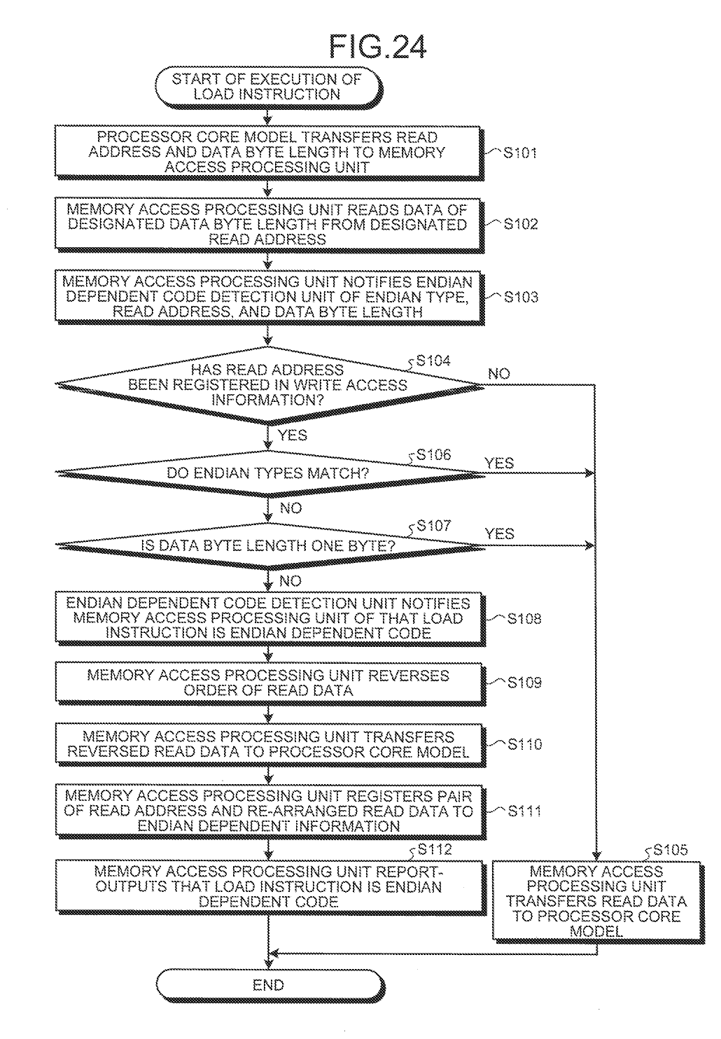

FIG. 24 is a flowchart for explaining an operation of the development system 700 when the load instruction is executed in the first simulation (that is, the simulation in step S91). A description will be made in connection with a case in which the processor core model 520 is an execution source of the load instruction.

First, when the load instruction is executed, the processor core model 520 transfers a read access request including a read address and a data byte length to the memory access processing unit 740 (step S101). The memory access processing unit 740 reads data designated by the data byte length from the position designated by the read address in the memory model 550 (step S102). The memory access processing unit 740 notifies the endian dependent code detection unit 560 of the endian type “LE” of the processor core model 520, the read address, and the data byte length (step S103).

The endian dependent code detection unit 560 judges whether or not the address of the read destination has been registered to the write access information 561 by retrieving the write access information 561 using the designated read address as a retrieval key (step S104). When it is judges that the read address has not been registered to the write access information 561 (No in step S104), the memory access processing unit 740 transfers the read data to the processor core model 520 (step S105), and the operation when the load instruction is executed is finished.

When it is judges that the read address has been registered to the write access information 561 (Yes in step S104), the an-dependent code detection unit 560 judges whether or not the endian type (here, “little endian”) of the processor core model 520 that has request the read access matches the registered endian type (step S106). When it is judged as matched (Yes in step S106), the process proceeds to step S105.

When it is judged that the endian type of the processor core model 520 that has requested the read access matches the registered endian type (No in step S106), the endian dependent code detection unit 560 further judges whether or not the data byte length is one byte (step S107). When it is judged that the data byte length is one byte (Yes in step S107), the process proceeds to step S105.

When it is judged that the data byte length is not one byte (No in step S107), the endian dependent code detection unit 560 judges that the endian dependent code has been detected and notifies of the memory access processing unit 740 of the fact that the load instruction is the endian dependent code (step S108). When the notice is received, the memory access processing unit 740 reverses an order of the read address (step S109), transfers the reversed read data to the processor core model 520 (step S110), and registers a pair of the read address and the reversed read data to the endian dependent information 741 (step S111). The memory access processing unit 640 report-outputs that the load instruction that causes the read access request in the target program 507 is the endian dependent code (step S112), and the operation for executing the load instruction in the first simulation is finished.

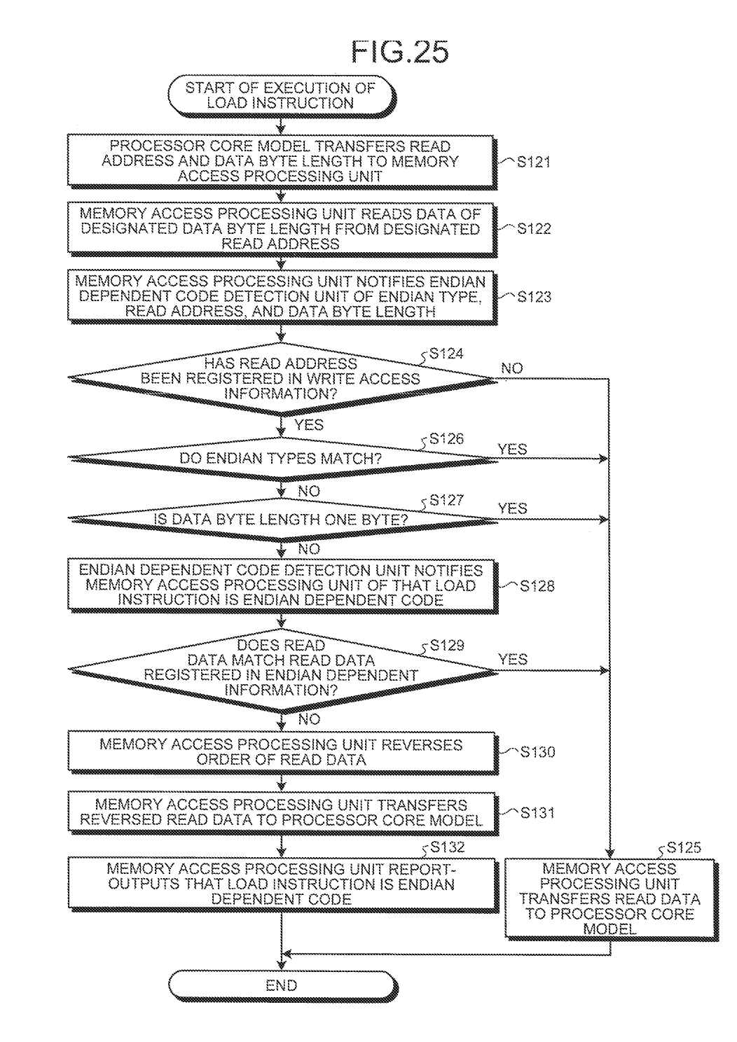

FIG. 25 is a flowchart for explaining an operation when the load instruction is executed in the second or later simulation (that is, the simulation in step S93). A description will be made in connection with a case in which the processor core model 520 is an execution source of the load instruction.

Operations in step S121 to step S128 is the same as in step S101 to step S108, respectively, and a description thereof is omitted.

If in step S128, the endian dependent code detection unit 560 notifies the memory access processing unit 740 of the fact that it is the endian dependent code, the filter unit 742 compares the read data read in step S122 with the read data registered to the endian dependent information 741 and judges whether both data match each other (step S129).

If the user has revised the corresponding endian dependent code, both data match each other. When it is judged that both data match each other (Yes in step S129), the process proceeds to step S125. However, when it is judged that both data do not match each other (No in step S129), the memory access processing unit 740 reverses an order of the read data (step S130), transfers the reversed read data to the processor core model 520 (step S131), and report-outputs that the load instruction that causes the read access request in the target program 507 is the endian dependent code (step S132), and the operation for executing the load instruction in the second or later simulation is finished.

As described above, according to the sixth embodiment of the present invention, the endian dependent information 731 and 741 in which the transmission data before transmission is previously recorded for each endian dependent code, and the filter units 732 and 742 that compares the corresponding transmission data before transmission obtained by the memory access processing units 730 and 740 with the transmission data before transmission recorded to the endian dependent information 731 and 741 and excludes a load instruction in which both transmission data match each other among load instructions that the endian dependent code detection unit 560 judges as the endian dependent code from the endian dependent code are further provided. The user can repetitively execute the revision process of the endian dependent code and detection of the endian dependent code that is not revised yet.

Further, in the sixth embodiment, since the endian dependent code is detected from the target program 507 that targets on the target system 400 that employs the byte-invariant method, the endian dependent information 731 and 741 and the filter units 732 and 742 are added to the fourth embodiment. However, by adding the components to the fifth embodiment, the endian dependent code can be detected from the target program 507 that targets on the target system 400 that employs the word-invariant method.

Further, a software development program for implementing the development system according to the fourth to sixth embodiments may be stored in a computer connected to a network such as the Internet and downloaded via the network for provision and distribution. Further, the software development program may be previously embedded in, for example, the ROM for provision. Further, the software development program may be stored in a CD-ROM or an external memory device for provision.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A development system, comprising:
an instruction set simulator that includes a processor model that executes an execution program by simulating a CPU and a memory model; and
a checker that monitors an access instruction, executed by the processor model, included in the execution program, on the memory model and, when a difference between a data length at the time of writing and a data length at the time of reading on the same position in the memory model is detected, notifies the code being executed at the time of the detection as an endian dependent.

2. The development system according to claim 1,
wherein the checker manages access history information in which a memory write instruction to memory area is recorded and detects a difference an endian dependent based on the access history information.

3. The development system according to claim 2,
wherein the checker monitors an operation of a stack pointer by the processor model and, when a pop operation is detected, deletes a record of the popped writing area from the access history information.

4. The development system according to claim 2,
wherein the execution program includes an initial value that is set to the memory model by a pseudo instruction on an assembler, and
the development system further comprises an information reception unit that receives an input of access history information related to the initial value.

5. The development system according to claim 1, further comprising:
a byte change unit that executes a byte change on an instruction included in the execution program while the processor model executing the instruction, and, when the instruction executed by the processor model is a multi-byte access instruction, performs a byte change of an access destination at the time of execution of the multi-byte access instruction.

6. The development system according to claim 2, further comprising:
a byte change unit that executes a byte change on an instruction included in the execution program while the processor model executing the instruction, and, when the instruction executed by the processor model is a multi-byte access instruction, performs a byte change of an access destination at the time of execution of the multi-byte access instruction.

7. The development system according to claim 3, further comprising:
a byte change unit that executes a byte change on an instruction included in the execution program while the processor model executing the instruction, and, when the instruction executed by the processor model is a multi-byte access instruction, performs a byte change of an access destination at the time of execution of the multi-byte access instruction.

8. The development system according to claim 4, further comprising:
a byte change unit that executes a byte change on an instruction included in the execution program while the processor model executing the instruction, and, when the instruction executed by the processor model is a multi-byte access instruction, performs a byte change of an access destination at the time of execution of the multi-byte access instruction.

9. The development system according to claim 5, wherein the memory model secures a byte change forbidden area where a byte change by the byte change unit is forbidden.

10. The development system according to claim 9, further comprising:
a hardware model that accesses the byte change forbidden area and is different from the Processor model.

11. A development system, comprising:
a first and second processor core models that simulates processor core respectively, the first and second processor cores models are different in endian type;
a memory model that simulates buffer memory that stores transmission data between the two processor core models;
an endian dependent code detection unit that, when the first processor core model executes a load instruction for reading transmission data written in the memory model, judges whether or not the load instruction is an endian dependent code, based on a read size of the load instruction; and
an endian dependent code notification unit that, when the endian dependent code detection unit judge that the load instruction is the endian dependent code, outputs that the load instruction is the endian dependent code.

12. The development system according to claim 11,
wherein the endian dependent code detection unit manages write access information in which a write address of writing data from the second processor core model to the memory model is recorded in association with an endian of the second processor core model, retrieves the write access information by using a read address of a load instruction when a processor core model executes the load instruction, determines whether the executed load instruction is a load instruction that causes the first processor core model to read transmission data or a load instruction that causes the second processor core model to read transmission data, based on whether or not an endian associated with the read address matches an endian of the processor core model that has executed the load instruction.

13. The development system according to claim 11, further comprising:
a conversion processing unit that obtains transmission data before transmission as a read target of a load instruction that the endian dependent code detection unit has judged as the endian dependent code and transfers the obtained transmission data before transmission to the first processor core model.

14. The development system according to claim 13,
wherein the two processor cores assign the same address to each of bytes that configure the buffer memory,
the endian dependent code detection unit judges a load instruction whose read size is multiple bytes among load instruction that cause the first processor core model to read transmission data as an endian dependent code.

15. The development system according to claim 14,
wherein the conversion processing unit obtains the transmission data before transmission by reading multi-byte data designated from a read address designated by a load instruction judged as the endian dependent code from the memory model according to an endian type of the first processor core model and reversing an order of each byte data that configures the read multi-byte data.

16. The development system according to claim 13,
wherein the two processor cores assign a different address to each byte that configures each word that configures the buffer memory according to an endian type, and
the endian dependent code detection unit judges a load instruction whose read size is less than a word among load instructions that cause the first processor core model to read transmission data as an endian dependent code.

17. The development system according to claim 16,
wherein the conversion processing unit obtains the transmission data before transmission by converting a read address designated by the load instruction to an address assigned by the second processor core model and reading transmission data from the converted read address according to an endian type of the first processor core model.

18. The development system according to claim 14, further comprising:
endian dependent information in which transmission data before transmission is previously recorded for each endian dependent code; and
a filter unit that compares corresponding transmission data before transmission obtained by the conversion processing unit with transmission data before transmission recorded in the endian dependent information and excludes a load instruction in which both transmission data match each other among load instructions that the endian dependent code detection unit has judged as the endian dependent code from the endian dependent code.

19. The development system according to claim 15, further comprising:
endian dependent information in which transmission data before transmission is previously recorded for each endian dependent code; and
a filter unit that compares corresponding transmission data before transmission obtained by the conversion processing unit with transmission data before transmission recorded in the endian dependent information and excludes a load instruction in which both transmission data match each other among load instructions that the endian dependent code detection unit has judged as the endian dependent code from the endian dependent code.

20. The development system according to claim 16, further comprising:
endian dependent information in which transmission data before transmission is previously recorded for each endian dependent code; and
a filter unit that compares corresponding transmission data before transmission obtained by the conversion processing unit with transmission data before transmission recorded in the endian dependent information and excludes a load instruction in which both transmission data match each other among load instructions that the endian dependent code detection unit has judged as the endian dependent code from the endian dependent code.
